(19) United States
(12) Patent Application Publication
(10) Pub. No.: US 2023/0128378 A1
(43) Pub. Date: Apr. 27, 2023

(54) Method and Apparatus for Imposing Bitstream Constraints in Video Coding

(71) Applicant: HFI Innovation Inc., Zhubei City, Hsinchu County (TW)

(72) Inventor: Shih-Ta HSIANG, Hsinchu City (TW)

(21) Appl. No.: 17/997,039

(22) PCT Filed: Apr. 26, 2021
(86) PCT No.: PCT/CN2021/089824

§ 371 Date: Oct. 25, 2022

Related U.S. Application Data
(60) Provisional application No. 63/017,702, filed on Apr. 30, 2020.
(60) Provisional application No. 63/017,704, filed on Apr. 30, 2020.

(51) Int. Cl. H04N 19/70; H04N 19/172; H04N 19/30

(52) U.S. Cl. CPC H04N 19/70; H04N 19/172; H04N 19/30

(57) ABSTRACT

A method and apparatus for signaling or parsing general constraint information are disclosed. According to the method for the decoder side, a video bitstream comprising a current picture is received. A first syntax of general constraint information related to one or more explicit scaling list constraints is parsed from the video bitstream, where when a value of the first syntax indicates constraint of no_explicit_scaling_list being imposed, a second syntax has a mandatory value to indicate that use of an explicit scaling list in an SPS (sequence parameter set) level is disabled. The value of the second syntax indicates that the use of the explicit scaling list is enabled or not in the SPS level. The explicit scaling list is derived from the video bitstream when the second syntax has a value other than the mandatory value. The current picture is decoded utilizing information comprising the explicit scaling list.

### CROSS REFERENCE TO RELATED APPLICATIONS

The present invention claims priority to U.S. Provisional Patent Application, Ser. No. 63/017,702, filed Apr. 30, 2020 and U.S. Provisional Patent Application, Ser. No. 63/017,704, filed Apr. 30, 2020. The U.S. Provisional Patent Applications are hereby incorporated by reference in their entireties.

### FIELD OF THE INVENTION

The present invention relates to video coding system. In particular, the present invention relates to signaling general constraint information.

### BACKGROUND

High-efficiency video coding (HEVC) is the latest international video coding standard developed by the Joint Collaborative Team on Video Coding (JCT-VC) (Rec. ITU-T H.265 ISO/IEC 23008-2 version 3: High Efficiency Video Coding, April, 2015). FIG. 1 provides the block diagram of the HEVC encoding system. The input video signal is predicted from the reconstructed signal (136), which is derived from the coded picture regions using Inter/Intra prediction (110). The prediction residual signal is processed by a linear transform (118). The transform coefficients are quantized (120) and entropy coded (122) together with other side information in the bitstream. The reconstructed signal (128) is generated from the prediction signal and the reconstructed residual signal after inverse transform (126) on the de-quantized transform coefficients (124). The reconstructed signal is further processed by in-loop filtering (e.g., de-blocking filter (DF) 130 and NDFs 131) for removing coding artifacts. The decoded pictures are stored in the frame buffer (134) for predicting the future pictures in the input video signal.

In HEVC, a coded picture is partitioned into non-overlapped square block regions represented by the associated coding tree units (CTUs). A coded picture can be represented by a collection of slices, each comprising an integer number of CTUs. The individual CTUs in a slice are processed in a raster scanning order. A bi-predictive (B) slice may be decoded using intra prediction or inter prediction using at most two motion vectors and reference indices to predict the sample values of each block. A predictive (P) slice is decoded using intra prediction or inter prediction using at most one motion vector and reference index to predict the sample values of each block. An intra (I) slice is decoded using intra prediction only.

A CTU can be partitioned into multiple non-overlapped coding units (CUs) using the recursive quadtree (QT) structure to adapt to various local motion and texture characteristics. One or more prediction units (PU) are specified for each CU. The prediction unit, together with the associated CU syntax, works as a basic unit for signaling the predictor information. The specified prediction process is employed to predict the values of the associated pixel samples inside the PU. A CU can be further partitioned using the residual quadtree (RQT) structure for representing the associated prediction residual signal. The leaf nodes of the RQT correspond to the transform units (TUs). A transform unit is comprised of a transform block (TB) of luma samples of size 8×8, 16×16, or 32×32 or four transform blocks of luma samples of size 4×4, and two corresponding transform blocks of chroma samples of a picture in 4:2:0 color format. An integer transform is applied to a transform block and the level values of quantized coefficients together with other side information are entropy coded in the bitstream. FIG. 2 illustrates an example of the block partitioning 210 (left) and its corresponding QT representation 220 (right). The solid lines indicate the CU boundaries and the dashed lines indicate the TU boundaries.

The terms coding tree block (CTB), coding block (CB), prediction block (PB), and transform block (TB) are defined to specify the 2-D sample array of one color component associated with CTU, CU, PU, and TU, respectively. Thus, a CTU consists of one luma CTB, two chroma CTBs, and associated syntax elements. A similar relationship is valid for CU, PU, and TU. The tree partitioning is generally applied simultaneously to both luma and chroma, although exceptions apply when certain minimum sizes are reached for chroma.

In HEVC, a transform block can be coded without a transform operation, indicated by a syntax element transform_skip_flag signaled for a non-empty transform block (i.e., with at least one coded non-zero sample value). High-level control of this TU coding mode is signaled by the picture parameter set (PPS) syntax elements transform_skip_enabled_flag and log2_max_transform_skip_block_size_minus2. When transform_skip_enabled_flag is equal to 1, transform_skip_flag is coded for each non-empty transform block with block width less than or equal to 1<<(log2_max_transform_skip_block_size_minus2+2). When transform_skip_flag is equal to 1, the associated transform block is coded in the transform skip (TS) mode. Otherwise, a transform is applied to the associated transform block. transform_skip_flag is inferred to be equal to 0 when not coded.

The Joint Video Experts Team (JVET) of ITU-T SG16 WP3 and ISO/IEC JTC1/SC29/WG11 is currently in the process of establishing the next-generation video coding standard. Some promising new coding tools have been adopted into Versatile Video Coding (VVC) Draft in JVET-Q2001 (B. Bross J. Chen, S. Liu, “Versatile Video Coding (Draft 8),” Document of Joint Video Experts Team of ITU-T SG16 WP3 and ISO/IEC JTC1/SC29/WG11, JVET-Q2001, 17th Meeting: Brussels, BE, 7-17 Jan. 2020). In VVC Draft as specified in JVET-Q2001, a coded picture is partitioned into non-overlapped square block regions represented by CTUs, similar to HEVC. Each CTU can be partitioned into one or multiple smaller size coding units (CUs) by a quadtree with nested multi-type tree using binary and ternary split. The resulting CU partitions can be in square or rectangular shapes.

### BRIEF SUMMARY OF THE INVENTION

A method and apparatus for signaling or parsing general constraint information are disclosed. According to the method for the decoder side, a video bitstream comprising a current picture is received. A first syntax of general constraint information related to one or more explicit scaling list constraints is parsed from the video bitstream, where when a value of the first syntax indicates constraint of no_explicit_scaling_list being imposed, a second syntax has a mandatory value to indicate that use of an explicit scaling list in an SPS (sequence parameter set) level is disabled. The value of the second syntax indicates that the use of the explicit scaling list is enabled or not in the SPS level. The explicit scaling list is derived from the video bitstream when the second syntax has a value other than the mandatory value. The current picture is decoded utilizing information comprising the explicit scaling list.

In one embodiment, when a third syntax indicates that a constraint of no_APS (adaptation parameter set) is imposed, the value of the first syntax is set to indicate no explicit scaling list constraint being imposed. In one embodiment, the third syntax corresponds to no_aps_constraint_flag.

In one embodiment, the first syntax corresponds to no_explicit_scaling_list_constraint_flag. In one embodiment, the second syntax corresponds to sps_explicit_scaling_list_enabled_flag.

According to the method for the encoder side, input data corresponding to a current picture are received. A first syntax related to one or more explicit scaling list constraints is signaled in a video bitstream, wherein the first syntax equal to a first value indicates no explicit scaling list constraint being imposed. When the first syntax equal to the first value, setting a value of a second syntax to indicate that use of an explicit scaling list in an SPS (sequence parameter set) level is disabled, wherein the second syntax is related to whether to enable the use of the explicit scaling list in the SPS level.

### BRIEF DESCRIPTION OF THE DRAWINGS

FIG. 1 illustrates an exemplary adaptive inter/intra video encoding system.

FIG. 2 illustrates an example of block partition, where a block partitioned result is shown on the left and a coding tree (also referred to as a partition tree structure) is shown on the right.

FIG. 3 illustrates a flowchart of an exemplary video decoding system according to an embodiment of the present invention, where a first syntax related to one or more explicit scaling list constraints is signaled or parsed from the video bitstream.

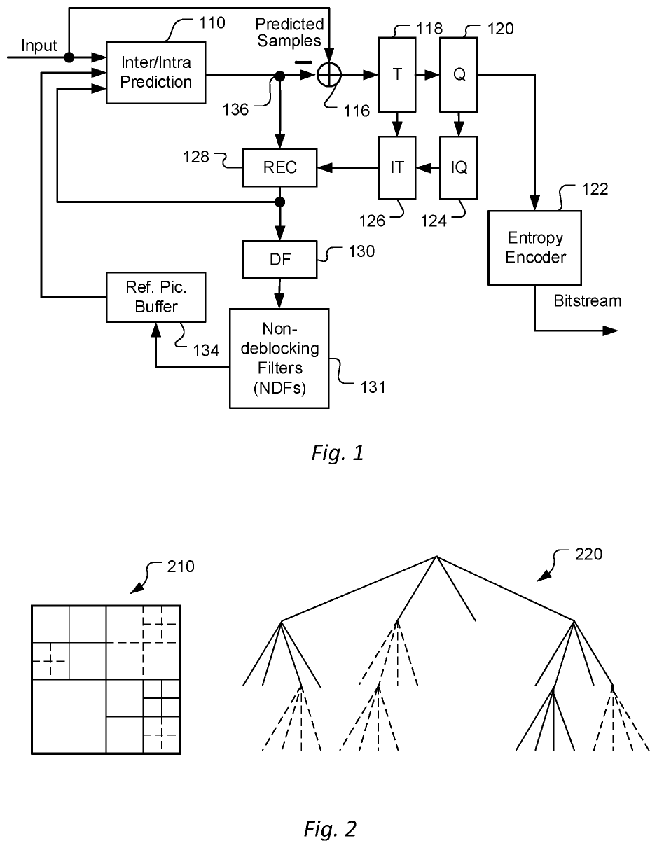

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the Versatile Video Coding (VVC) Draft as specified in JVET-Q2001, the syntax related to the general constraint information is signaled in the high-level syntax sets to specify the constraints imposed on the current bitstream. The syntax element no_lmcs_constraint_flag equal to 1 specifies that the value of the syntax element sps_lmcs_enabled_flag shall be equal to 0. The syntax element no_aps_constraint_flag equal to 1 specifies that there shall be no NAL unit with nuh_unit_type equal to PREFIX_APS_NUT or SUFFIX_APS_NUT present, and the values of the syntax elements sps_lmcs_enabled_flag and sps_scaling_list_enabled_flag shall both be equal to 0. APS (adaptation parameter set) is a syntax structure containing syntax elements that apply to zero or more slices as determined by zero or more syntax elements found in slice headers. LMCS (luma mapping with chroma scaling) is a process that is applied as part of the decoding process that maps luma samples to particular values and may apply a scaling operation to the values of chroma samples. The related syntax tables and semantics are provided as follows:

TABLE 1
General constraint information syntax

| | Descriptor |
|---|---|
| general_constraint_info( ) { | |
| ... | |
| no_act_constraint_flag | u(1) |
| no_lmcs_constraint_flag | u(1) |
| ... | |
| no_aps_constraint_flag | u(1) |
| ... | |
| } | |

The above syntax table corresponds to Clause 7.3.3.2 of JVET-Q2001. The general constraint information semantics in Clause 7.4.4.2 of JVET-Q2001 are described as follows:

no_act_constraint_flag equal to 1 specifies that sps_act_enabled_flag shall be equal to 0. no_act_constraint_flag equal to 0 does not impose such a constraint. ACT corresponds to adaptive colour transform.

no_lmcs_constraint_flag equal to 1 specifies that sps_lmcs_enabled_flag shall be equal to 0. no_lmcs_constraint_flag equal to 0 does not impose such a constraint.

no_aps_constraint_flag equal to 1 specifies that there shall be no NAL unit with nuh_unit_type equal to PREFIX_APS_NUT or SUFFIX_APS_NUT present in OlsInScope, and the sps_lmcs_enabled_flag and sps_scaling_list_enabled_flag shall both be equal to 0. no_aps_constraint_flag equal to 0 does not impose such a constraint.

The present disclosure reveals the modified syntax and semantics related to signaling the general constraints. According to one aspect of the present invention, when the general constraint of no NAL unit with nuh_unit_type equal to PREFIX_APS_NUT or SUFFIX_APS_NUT present is imposed, the general constraint of not enabling luma mapping with chroma scaling shall be imposed. It is because of the requirement of bitstream conformance that the value of sps_lmcs_enabled_flag shall be equal to 0 when no_aps_constraint_flag is equal to 1. An example of semantic modifications to VVC Draft according to the aspect with the modified part highlighted in Italic is as follows:

no_lmcs_constraint_flag equal to 1 specifies that sps_lmcs_enabled_flag shall be equal to 0. no_lmcs_constraint_flag equal to 0 does not impose such a constraint. When no_aps_constraint_flag is equal to 1, the value of no_lmcs_constraint_flag shall be equal to 1.

According to a further aspect of the present invention, the parsing order for the general constraint syntax can be adjusted such that no_aps_constraint_flag is parsed before no_lmcs_constraint_flag to facilitate bitstream conformance check.

According to another aspect of the present disclosure, a new syntax element no_explicit_scaling_list_constraint_flag is added to the general constraint information to specify whether the general constraint of not enabling the explicit scaling list is imposed. When the value of no_explicit_scaling_list_constraint_flag is equal to 1, it indicates that use of an explicit scaling list in an SPS level is disable; as a result, a second syntax, sps_explicit_scaling_list_enabled_flag shall have a mandatory value that is equal to 0. When no_aps_constraint_flag is equal to 1, the value of no_explicit_scaling_list_constraint_flag shall be equal to 1. The semantic of the syntax sps_explicit_scaling_list_enabled_flag is defined in JVET-Q2001 as follows:

When the value of sps_explicit_scaling_list_enabled_flag equal to 1, it specifies that the use of an explicit scaling list, which is signalled in a scaling list APS, in the scaling process for transform coefficients when decoding a slice is enabled for the CLVS. On the other hand, sps_explicit_scaling_list_enabled_flag equal to 0 specifies that the use of an explicit scaling list is disabled for the CLVS in the scaling process for transform coefficients when decoding a slice.

An example of semantic modifications to VVC Draft according to this aspect with the modified part highlighted in Italic is as follows:

no_explicit_scaling_list_constraint_flag equal to 1 specifies that sps_explicit_scaling_list_enabled_flag shall be equal to 0. no_explicit_scaling_list_constraint_flag equal to 0 does not impose such a constraint. When no_aps_constraint_flag is equal to 1, the value of no_explicit_scaling_list_constraint_flag shall be equal to 1.

In the Versatile Video Coding (VVC) Draft as specified in JVET-Q2001, the transform skip mode can be enabled by setting the syntax element sps_transform_skip_enabled_flag in the sequence parameter set (SPS) equal to 1. When sps_transform_skip_enabled_flag is equal to 1, the maximum allowed block size for the TS mode is further signaled by the syntax element log2_max_transform_skip_block_size_minus2 in the SPS. The syntax element sps_bdpcm_enabled_flag is further signaled to indicate whether the block-based delta pulse code modulation (BDPCM) is enabled in the coded layer video sequence (CLVS) referring to the SPS. Two methods are supported for coding the residual blocks in transform skip mode (with the value of the associated syntax element transform_skip_flag equal to 1). When the syntax element slice_ts_residual_coding_disabled_flag in the slice header is equal to 0, the transform skip residual coding process with the syntax table specified by residual_ts_coding( ) in JVET-Q2001 is employed for coding residual blocks in transform skip mode in the current slice. When slice_ts_residual_coding_disabled_flag is equal to 1, the transform skip residual coding process residual_ts_coding( ) is disabled and the regular residual coding process with the syntax table specified by residual_coding( ) in JVET-Q2001 is employed for coding residual blocks in transform skip mode in the current slice. When either dependent quantization or sign data hiding coding tool is enabled for the current slice, residual_coding( ) is not allowed for coding residual blocks in transform skip mode. Therefore, slice_ts_residual_coding_disabled_flag is signaled only when sps_transform_skip_enabled_flag is equal to 1 and both slice_dep_quant_enabled_flag and slice_sign_data_hiding_enabled_flag are equal to 0. When not present, the value of slice_ts_residual_coding_disabled_flag is inferred to be equal to 0. VVC Draft further comprises signaling the general constraint syntax related to using transform skip mode. The syntax element no_transform_skip_constraint_flag equal to 1 specifies that sps_transform_skip_enabled_flag shall be equal to 0. The syntax element no_tsrc_constraint_flag equal to 1 specifies that slice_ts_residual_coding_disabled_flag shall be equal to 1. The syntax element no_bdpcm_constraint_flag equal to 1 specifies that sps_bdpcm_enabled_flag shall be equal to 0. The high-level syntax tables and semantics related to transform skip mode are provided as follows:

TABLE 2
Sequence parameter set RBSP syntax

| | Descriptor |
|---|---|
| seq_parameter_set_rbsp( ) { | |
| sps_seq_parameter_set_id | u(4) |
| sps_video_parameter_set_id | u(4) |
| ..... | |
| sps_transform_skip_enabled_flag | u(1) |
| if( sps_transform_skip_enabled_flag ) { | |
| log2_transform_skip_max_size_minus2 | ue(v) |
| sps_bdpcm_enabled_flag | u(1) |
| } | |
| .... | |
| } | |

The above syntax table corresponds to Clause 7.3.2.3 of JVET-Q2001. The general constraint information syntax in Clause 7.3.3.2 of JVET-Q2001 is shown in the following table:

TABLE 3
General constraint information syntax

| | Descriptor |
|---|---|
| general_constraint_info( ) { | |
| .... | |
| no_transform_skip_constraint_flag | u(1) |
| no_tsrc_constraint_flag | u(1) |
| no_bdpcm_constraint_flag | u(1) |
| .... | |
| } | |

The general slice header syntax in Clause 7.3.7.1 of JVET-Q2001 is shown in the following table:

TABLE 4
General slice header syntax

| | Descriptor |
|---|---|
| slice_header( ) { | |
| ... | |
| if( sps_dep_quant_enabled_flag ) | |
| slice_dep_quant_enabled_flag | u(1) |
| if( sps_sign_data_hiding_enabled_flag | |
| && !slice_dep_quant_enabled_flag ) | |
| slice_sign_data_hiding_enabled_flag | u(1) |
| if( sps_transform_skip_enabled_flag | |
| && !slice_dep_quant_enabled_flag && | |
| !slice_sign_data_hiding_enabled_flag ) | |
| slice_ts_residual_coding_disabled_flag | u(1) |
| ... | |
| } | |

The sequence parameter set RBSP semantics as specified in 7.4.3.3 of JVET-Q2001 are shown as follows:

sps_transform_skip_enabled_flag equal to 1 specifies that transform_skip_flag may be present in the transform unit syntax. sps_transform_skip_enabled_flag equal to 0 specifies that transform_skip_flag is not present in the transform unit syntax.

log2_transform_skip_max_size_minus2 specifies the maximum block size used for transform skip, and shall be in the range of 0 to 3, inclusive.

The variable MaxTsSize is set as follows:

MaxTsSize=1<<(log2_transform_skip_max_size_minus2+2).

sps_bdpcm_enabled_flag equal to 1 specifies that intra_bdpcm_luma_flag and intra_bdpcm_chroma_flag may be present in the coding unit syntax for intra coding units. sps_bdpcm_enabled_flag equal to 0 specifies that intra_bdpcm_luma_flag and intra_bdpcm_chroma_flag are not present in the coding unit syntax for intra coding units. When not present, the value of sps_bdpcm_enabled_flag is inferred to be equal to 0.

The general constraint information semantics as specified in 7.4.4.2 of JVET-Q2001 are shown as follows:

no_transform_skip_constraint_flag equal to 1 specifies that sps_transform_skip_enabled_flag shall be equal to 0. no_transform_skip_constraint_flag equal to 0 does not impose such a constraint.

no_tsrc_constraint_flag equal to 1 specifies that slice_ts_residual_coding_disabled_flag shall be equal to 1. no_tsrc_constraint_flag equal to 0 does not impose such a constraint.

no_bdpcm_constraint_flag equal to 1 specifies that sps_bdpcm_enabled_flag shall be equal to 0. no_bdpcm_constraint_flag equal to 0 does not impose such a constraint.

The general slice header semantics as specified in 7.4.8.1 of JVET-Q2001 are shown as follows:

slice_ts_residual_coding_disabled_flag equal to 1 specifies that the syntax structure residual_coding( ) is used to parse the residual samples of a transform skip block for the current slice. slice_ts_residual_coding_disabled_flag equal to 0 specifies that the syntax structure residual_ts_coding( ) is used to parse the residual samples of a transform skip block for the current slice. When slice_ts_residual_coding_disabled_flag is not present, it is inferred to be equal to 0.

The present disclosure reveals the modified general constraints related to use of transform skip mode. In VVC Draft, when no_tsrc_constraint_flag in the general constraint syntax is equal to 1, slice_ts_residual_coding_disabled_flag shall be equal to 1 for each associated slice header. In order to satisfy this constraint, slice_ts_residual_coding_disabled_flag shall be explicitly signaled in the bitstream with the value equal to 1 for each slice header. Moreover, sps_transform_skip_enabled_flag shall be equal to 1 in the SPS and both slice_dep_quant_enabled_flag and slice_sign_data_hiding_enabled_flag shall be equal to 0 for each slice header (to allow signaling slice_ts_residual_coding_disabled_flag explicitly in the bitstream).

According to one aspect of the present disclosure, the general constraint of not using the transform skip residual coding process can further be satisfied by not enabling the transform skip mode. In this way, under the constraint of not using the transform skip residual coding process, slice_ts_residual_coding_disabled_flag is not required to be equal to 1 when sps_transform_skip_enabled_flag is equal to 0. Dependent quantization or sign bit hiding coding tool can still be enabled for lossy coding by disabling transform skip mode. An example of semantic modifications to VVC Draft according to the aspect with the modified part highlighted in Italic is as follows:

no_tsrc_constraint_flag equal to 1 specifies that slice_ts_residual_coding_disabled_flag shall be equal to 1 or sps_transform_skip_enabled_flag shall be equal to 0. no_transform_skip_constraint_flag equal to 0 does not impose such a constraint.

An alternative example of semantic modifications to VVC Draft according to the aspect with the modified part highlighted in Italic is as follows:

no_tsrc_constraint_flag equal to 1 specifies that slice_ts_residual_coding_disabled_flag shall be equal to 1 when sps_transform_skip_enabled_flag is equal to 1. no_transform_skip_constraint_flag equal to 0 does not impose such a constraint.

According to another aspect of the present disclosure, the semantics of slice_ts_residual_coding_disabled_flag can be modified such that slice_ts_residual_coding_disabled_flag is inferred to be equal to 1 when sps_transform_skip_enabled_flag is equal to 0. In this way, under the general constraint of not using the transform skip residual coding process, dependent quantization or sign bit hiding can still be enabled by disabling transform skip mode. An example of semantic modifications to VVC Draft according to this aspect with the modified part highlighted in Italic is as follows:

slice_ts_residual_coding_disabled_flag equal to 1 specifies that the syntax structure residual_coding( ) is used to parse the residual samples of a transform skip block for the current slice. slice_ts_residual_coding_disabled_flag equal to 0 specifies that the syntax structure residual_ts_coding( ) is used to parse the residual samples of a transform skip block for the current slice. When slice_ts_residual_coding_disabled_flag is not present, //*it is inferred to be equal to 0. *// the following applies:
If sps_transform_skip_enabled_flag is equal to 0, the value of slice_ts_residual_coding_disabled_flag is inferred to be equal to 1.
Otherwise, the value of slice_ts_residual_coding_disabled_flag is inferred to be equal to 0.

In the above modification, texts between “//*” and “*//” indicate deletion. According to another aspect of the present disclosure, the general constraint of not enabling transform skip mode shall further impose the constraints on using other tools related to transform skip mode. For example, when the general constraint of not enabling transform skip mode is imposed, the general constraint of not enabling BDPCM and the general constraint of not using the transform skip residual coding process shall be also imposed. An example of semantic modifications to VVC Draft according to this aspect with the modified part highlighted in Italic is as follows:

no_transform_skip_constraint_flag equal to 1 specifies that sps_transform_skip_enabled_flag shall be equal to 0. no_transform_skip_constraint_flag equal to 0 does not impose such a constraint.

no_tsrc_constraint_flag equal to 1 specifies that slice_ts_residual_coding_disabled_flag shall be equal to 1. no_tsrc_constraint_flag equal to 0 does not impose such a constraint. When no_transform_skip_constraint_flag is equal to 1, the value of no_tsrc_constraint_flag shall be equal to 1.

no_bdpcm_constraint_flag equal to 1 specifies that sps_bdpcm_enabled_flag shall be equal to 0. no_bdpcm_constraint_flag equal to 0 does not impose such a constraint. When no_transform_skip_constraint_flag is equal to 1, the value of no_bdpcm_constraint_flag shall be equal to 1.

Any of the foregoing proposed methods can be implemented in encoders and/or decoders. For example, any of the proposed methods can be implemented in a high-level syntax encoding module an encoder, and/or a high-level syntax decoding module of a decoder. Alternatively, any of the proposed methods can be implemented as a circuit integrated to the high-level syntax encoding module of the encoder and/or the high-level syntax decoding module of the decoder. Any of the foregoing proposed methods can also be implemented in image encoders and/or decoders, wherein the resulting bitstream corresponds to one coded frame only using intra-picture prediction.

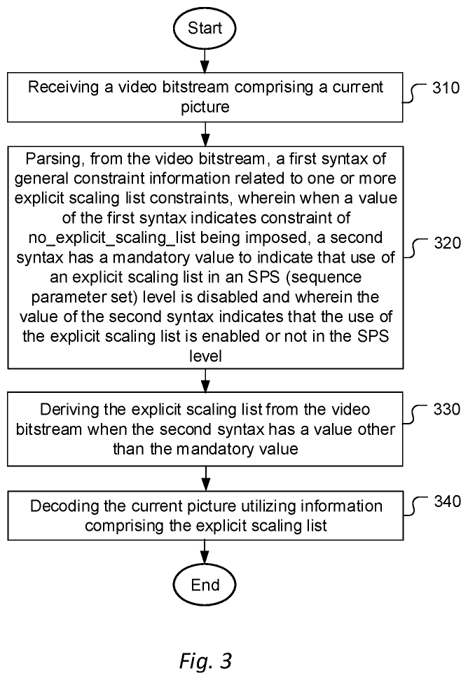

FIG. 3 illustrates a flowchart of an exemplary video decoding system according to an embodiment of the present invention, where a first syntax related to one or more explicit scaling list constraints is signaled or parsed from the video bitstream. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, a video bitstream comprising a current picture is received in step 310. A first syntax of general constraint information related to one or more explicit scaling list constraints is parsed from the video bitstream in step 320, wherein when a value of the first syntax indicates no explicit scaling list constraint being imposed, a second syntax has a mandatory value to indicate that use of an explicit scaling list in an SPS (sequence parameter set) level is disabled and wherein the value of the second syntax indicates that the use of the explicit scaling list is enabled or not in the SPS level. The explicit scaling list is derived from the video bitstream when the second syntax has a value other than the mandatory value in step 330. The current picture is decoded utilizing information comprising the explicit scaling list in step 340.

A flowchart of an exemplary video encoding system corresponding to the decoder in FIG. 3 can be derived accordingly.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for decoding a video sequence, the method comprising:
receiving a video bitstream comprising a current picture;
parsing, from the video bitstream, a first syntax of general constraint information related to one or more explicit scaling list constraints, wherein when a value of the first syntax indicates constraint of no_explicit_scaling_list being imposed, a second syntax has a mandatory value to indicate that use of an explicit scaling list in an SPS (sequence parameter set) level is disabled and wherein the value of the second syntax indicates that the use of the explicit scaling list is enabled or not in the SPS level;
deriving the explicit scaling list from the video bitstream when the second syntax has a value other than the mandatory value; and
decoding the current picture utilizing information comprising the explicit scaling list.

2. The method of claim 1, wherein when a third syntax indicates that a constraint of no_APS (adaptation parameter set) is imposed, the value of the first syntax is set to indicate no explicit scaling list constraint being imposed.

3. The method of claim 2, wherein the third syntax corresponds to no_aps_constraint_flag.

4. The method of claim 1, wherein the first syntax corresponds to no_explicit_scaling_list_constraint_flag.

5. The method of claim 1, wherein the second syntax corresponds to sps_explicit_scaling_list_enabled_flag.

6. An apparatus for decoding a video sequence, the apparatus comprising one or more electronic circuits or processors arranged to:
receive a video bitstream comprising a current picture;
parse, from the video bitstream, a first syntax of general constraint information related to one or more explicit scaling list constraints, wherein when a value of the first syntax indicates constraint of no_explicit_scaling_list being imposed, a second syntax has a mandatory value to indicate that use of an explicit scaling list in an SPS (sequence parameter set) level is disabled and wherein the value of the second syntax indicates that the use of the explicit scaling list is enabled or not in the SPS level;
derive the explicit scaling list from the video bitstream when the second syntax has a value other than the mandatory value; and
decode the current picture utilizing information comprising the explicit scaling list.

7. A method for encoding a video sequence, the method comprising:
receiving input data corresponding to a current picture;
signaling, in a video bitstream, a first syntax related to one or more explicit scaling list constraints, wherein the first syntax equal to a first value indicates no explicit scaling list constraint being imposed; and
when the first syntax equal to the first value, setting a value of a second syntax to indicate that use of an explicit scaling list in an SPS (sequence parameter set) level is disabled, wherein the second syntax is related to whether to enable the use of the explicit scaling list in the SPS level.

8. The method of claim 7, wherein when a third syntax indicates that no APS (adaptation parameter set) constraint is imposed, the value of the first syntax is set to indicate no explicit scaling list constraint being imposed.

9. The method of claim 8, wherein the third syntax corresponds to no_aps_constraint_flag.

10. The method of claim 7, wherein the first syntax corresponds to no_explicit_scaling_list_constraint_flag.

11. The method of claim 7, wherein the second syntax corresponds to sps_explicit_scaling_list_enabled_flag.

12. An apparatus for encoding a video sequence, the apparatus comprising one or more electronic circuits or processors arranged to:
receive input data corresponding to a current picture;
signal, in a video bitstream, a first syntax related to one or more explicit scaling list constraints, wherein the first syntax equal to a first value indicates no explicit scaling list constraint being imposed; and
when the first syntax equal to the first value, set a value of a second syntax to indicate that use of an explicit scaling list in an SPS (sequence parameter set) level is disabled, wherein the second syntax is related to whether to enable the use of the explicit scaling list in the SPS level.
